(19) United States
(12) Patent Application Publication
(10) Pub. No.: US 2003/0021409 A1
(43) Pub. Date: Jan. 30, 2003

(54) Alphabet soup cryptography

(76) Inventors: Joseph S. Incarnato, Silver Spring, MD (US); William M. Auslander, Herndon, VA (US)

Correspondence Address: JOSEPH S INCARNATO, 1008 TRACY DRIVE, SILVER SPRING, MD, 20904, US

(21) Appl. No.: 10/054,396

(22) Filed: Jan. 24, 2002

Related U.S. Application Data
(63) Continuation-in-part of application No. 09/429,087, filed on Oct. 29, 1999, now abandoned.

(51) Int. Cl. H04K 1/00

(52) U.S. Cl. 380/28

(57) ABSTRACT

This invention relates to modem day computers wherein communication methods, systems, and devices are embodied, which computers are capable of being connected to both hard wired telephone systems, and wireless information transmission systems. Said computer's methods, systems, and devices, being capable of providing automatic permutations of a Vigenere Square matrix whereby messages are encrypted. A method for automatically converting message characters from a literal message to encrypted characters forming an encrypted message called a one-time pad is disclosed. In accordance with the method, system, and devices of the present invention a conversion matrix known as a Vigenere Square is provided in conjunction with a device hereinafter called a Sliding Scale. The said sliding scale's interaction with the matrix is controlled by a computer program, which controls the responses of the sliding scale to applicable algorithms contained herein. All of the sliding scale attributes and actions, and the Vigenere Square matrix characteristics have been programmed in a high level computer language. This computer program is a step by step procedure for encrypting and decrypting messages and is capable of being contained on computer drives, and/or floppy discs, and other computer storage media.

This application is a Continuation in Part of application Ser. No. 09/429,087 filed Oct. 29, 1999 and now abandoned.

### BACKGROUND OF THE INVENTION

This invention relates to a method and system for encrypted data processing in general and, in particular, to a method, system, and devices, for exchanging encrypted information between data processing systems. Still more particularly the present invention relates to a method and system for converting literal message characters into encrypted characters, and for converting encrypted characters into literal message characters.

### SUMMARY AND OBJECTS OF THE INVENTION

This invention relates to computer systems containing devices that have been programmed with an encryption method, which method will yield an encrypted one-time pad by automatically permutating a Vigenere Square matrix containing scrambled alphabets, numbers, and symbols. It is an object of this invention to provide an improved method, system, and devices, for data encryption and for encrypted data processing.

Another object of the invention is to provide a device which accepts a literal character input from a computer keyboard and automatically transposes it into an encrypted character in accordance with said matrix.

Another object of the invention is to provide the device with decryption capabilities wherein input of the encrypted data is automatically reversed through the matrix thereby outputing the literal characters in readable format.

Another object of the invention is to provide an automatic enciphering-deciphering device which accepts literal messages which are unprocessed, or encrypted messages, processes them through said matrix, outputting translations of either.

Another object of the invention is to provide a multiplicity of devices that can automatically transpose a literal message character into a literal encrypted character derived from said matrix.

Another object of the invention is to provide automatic Vigenere Square enciphering-deciphering devices which automatically accepts plain text literal messages and automatically transposes them into a continuous enciphered literal datastream.

Another object of the invention is to provide a device herein called a Sliding Scale upon which are appended all the characters corresponding to a written national language, comprising letters, numerals, and symbols necessary to encrypting a message when operated in coordination with said matrix.

Another object of the invention is to provide said sliding scale with an Index Pointer appended thereto, necessary to positioning of said sliding scale in relation to the matrix for the purpose of encrypting or decrypting literal messages.

Another object of the invention is to provide a computer program device wherein keyboard input to a computer causes all carriage returns and spacing functions to be transposed and assigned literal encrypted characters from said matrix, the resulting output being an enciphered continuous datastream, except in those cases where carriage returns and spacing have been assigned as encrypted literal characters and appear as blanks in the encrypted datastream.

Another object is to provide a deciphering device which automatically accepts enciphered data and deciphers it to its original format, rendering them legible in their intended format. Another object of the invention is to automatically provide an encrypted output datastream forming a message called a “one-time pad”.

A Vigenere Square is a well known type of polyalphabetic enciphering-deciphering matrix, one form of which is shown in FIG. 1. The FIG. 1 matrix is representative of the operation of the disclosed embodiment of the invention. For enciphering purposes, the horizontal alphabet row outside and across the top of the matrix represents the Sliding Scale with its appended message characters, and the vertical arrow represents the appended index pointer. The Sliding Scale is a separate device from the Vigenere Square moving independently of the matrix. The sliding scale may have appended to it characters, ideaograms, pictograms of any written language which is used to transfer information. The sliding scale and the matrix used in this disclosure do not limit the size of either. They can be expanded to include many languages, numbering systems and characters to any maximum length desired. For the purposes of this dis closure, although not limited to this number the sliding scale described comprises a lower and upper case English alphabet, the numerals 0 through 9, and all of the symbols and punctuation marks mounted on the keys of a 104 key expanded computer keyboard, including the space key, and the carriage return key. This combination yields 96 characters appended to the sliding scale. The Vigenere Square in the present disclosure will have the same number of rows and columns as the number of characters on the sliding scale comprising a matrix having 9216 sub-squares, or positions, within it's outer boundaries. Each of these sub-squares will have an encryption character assigned to it, including spacing and carriage return. Each of these sub-squares will be numbered consecutively from the upper left corner starting at 0, and reading from left to right through 95, thence descending row by row consecutively through all 96 rows, exiting at the lower right corner from position 9215. Each of these 9216 sub-squares, or positions, are hereinafter called entry points wherein the index pointer on the sliding scale may be positioned to initiate the enciphering of a message. Each entry point in the matrix will contain a literal encrypted character except for the blank spacer, and carriage return, although blank, non-the-less representing an encrypted character, which will be used as encrypted characters in encrypted messages.

In accordance with the present invention, the encryption process is accomplished in the following manner comprising the steps of:

a. an entry point is chosen in the matrix;

b. the index pointer on the sliding scale is positioned above the entry point, which can be any one of the 9216 entry points in the matrix;

c. the message character mounted on the sliding scale to be encrypted is chosen;

d. the character immediately below it, being in the matrix and in the same row as the entry point is selected as the first encrypted character of the message;

e. the index pointer is then positioned over the first encrypted character;

f. the next message character mounted on the sliding scale to be encrypted is chosen;

g. the encrypted character immediately below this second chosen message character, and being in the matrix becomes the second encrypted character of the message.

In this manner proceeding from one encrypted character to the next via the repositioning of the index pointer a message of any length may be encrypted, wherein each character of the encrypted message is dependent on the preceding encrypted character. In those cases when the index pointer is positioned such that the sliding scale extends beyond the end of the row in which it is positioned, the excess portion of the sliding scale wraps back to the beginning of that same row. These actions and interactions of the sliding scale with the matrix, are pictorially represented in FIGS. 3, 4, and 5. The algorithms defining both the encryption and decryption of this method are disclosed on Pages 8, 9, and 10. These algorithms are contained on hard disks and other computer useable medium for the purpose of converting literal message characters to literal encrypted message characters.

### BRIEF DESCRIPTION OF DRAWINGS

FIG. 1. is a Vigenere Square matrix with a horizontal row outside and across the top of the matrix. This outside row, hereinafter called the sliding scale is a separate device from the matrix and is shown with an affixed index pointer. The sliding scale with its affixed index pointer moves as one complete unit, independently of the matrix, but in coordination with it as directed by the computer program installed on the computer drive or disks. It can move left to right or right to left and vertically in either direction.The actions and motions of, and the literal message characters of the sliding scale are contained in said computer program which directs the sliding scale's coordinated interaction with the matrix, which matrix whose literal encrypted characters are also contained in said computer program;

FIG. 2. is an abbreviated schematic of a Vigenere Square matrix, indicating the size of the present invention, being comprised of 96 rows and 96 columns. In practice except as described herein each of these rows and columns contain the same characters as those on the sliding scale, although the characters of the Vigenere Square are randomly scrambled. It is not necessary that the message characters of the sliding scale be of the same language as those in the Vigenere Square. The languages may vary, i.e., the sliding scale in English and the matrix characters in Sanscrit, or the sliding scale in Russian and the matrix in Japanese ideaograms. The national language to be encrypted is present on the sliding scale, and the encrypted characters are present in the Vigenere Square matrix. The combinations are many and varied wherein the sliding scale and the Vigenere Square matrix may each correspond to characters of differing written languages. FIG. 2. in its rendition is only an illustrative example of an English representation of a matrix.

FIG. 3, FIG. 4., AND FIG. 5. are all abbreviated schematics of a Vigenere Square matrix with an attendant sliding scale and it's appended index pointer.

FIG. 3. shows the initiation of encoding a message by selection of an entry point and overlaying the sliding scale with its appended index pointer above the entry point, 4,(being in row 1) which contains the letter P. The first letter of the message to be encoded is C on the sliding scale and the symbol beneath it and being in the same row as the entry point (row 1) is A, which is the first encoded symbol of the encoded message. Although this initial entry point chosen is in row 1, any entry point from 0 to 9215 may be chosen in any of the 96 rows.

FIG. 4. shows the choosing of the second encrypted symbol of the encrypted message. Move the sliding scale to the row(row 2) beneath the row from which the first encoded symbol of the message was picked. Position its index pointer over the symbol Z (the inferred second entry point) in this second row, which is immediately below the A which was chosen as the first encoded symbol of the message. The second letter of the message which is to be encoded is an E. Move down the sliding scale to the letter E on it. The symbol beneath it, being in the second row of the matrix, with the inferred second entry point is the symbol R (in row 2) which is the second encoded symbol of the encrypted message.

FIG. 5. shows the choosing of the third encrypted symbol of the encoded message. Move the sliding scale to the row (row 3)beneath the row (row 2)from which the second encrypted symbol was chosen. Position its index pointer above the U in row 3 (the symbol below the R symbol in row 2)and move down the sliding scale to third letter to be encrypted, being D on the sliding scale. The symbol beneath the D of the sliding scale, and being in the third row is a K which is the third encrypted symbol of the encrypted message. Thus the letters CED are encrypted to the symbols ARK.

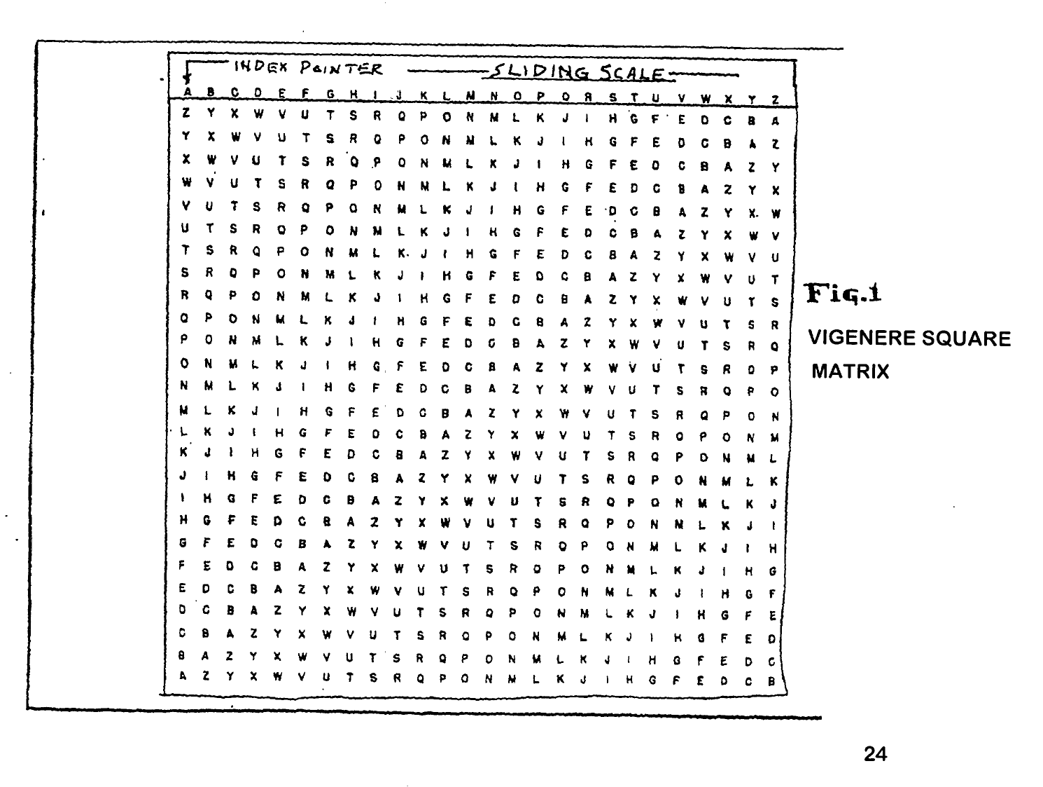

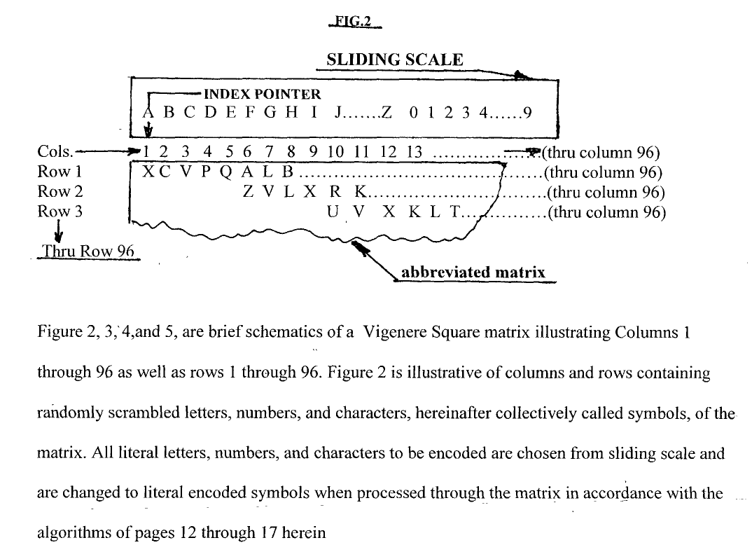

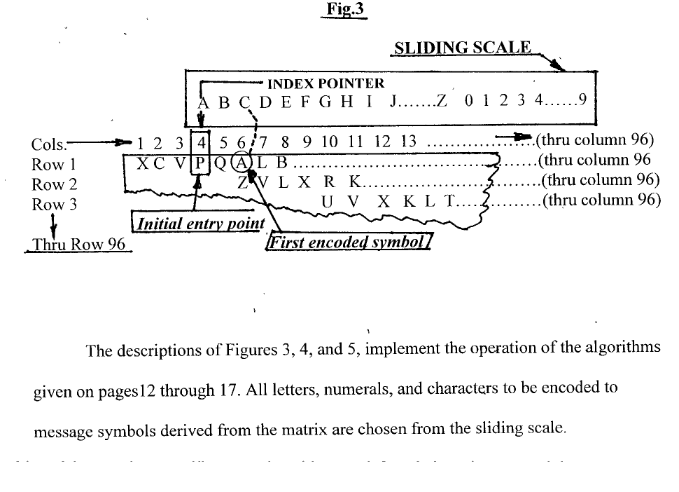

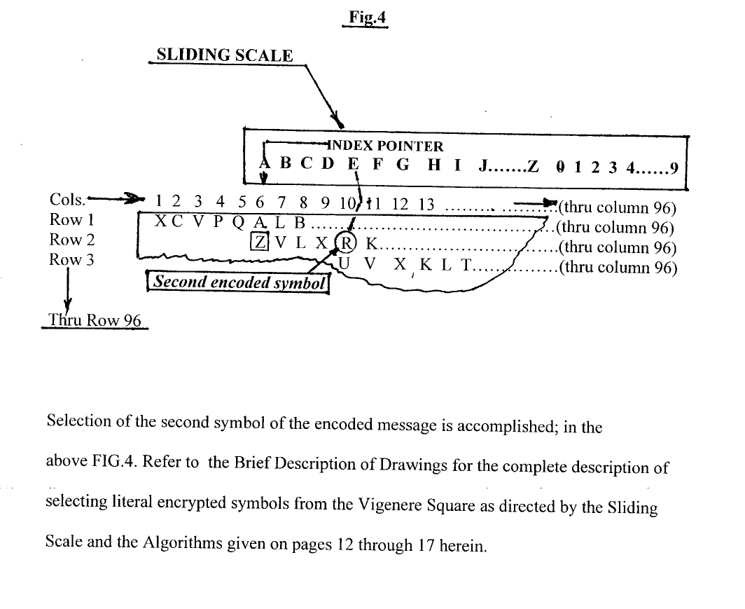

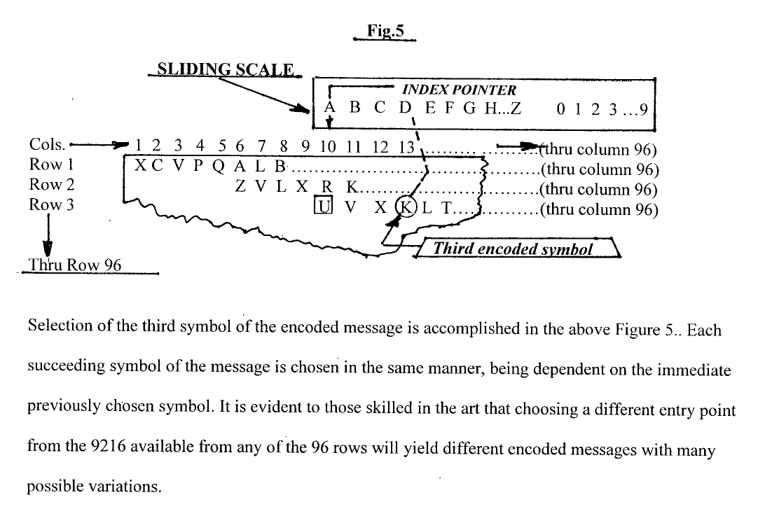

Each succeeding symbol of the encrypted message is chosen in the same manner, being dependent on the previous chosen symbol and it's entry point. It is evident that choosing a different initial entry point will yield a different encrypted message with thousands of possible variations.

It should be noted that if an entry point is chosen such that the sliding scale extends beyond the end of a row, the sliding scale wraps back to the beginning of the same row.

### DESCRIPTION OF PREFERRED EMBODIMENT

The present invention may be embodied in a variety of computers under a number of different operating systems. The computer may be, for example, a personal computer, a mid-range computer, a mainframe computer, or a supercomputer. In addition the computers may be a stand-alone system or part of a network such as a local-area network (Lan), or a wide-area network(WAN).

The preferred embodiment of this invention consists of a computer system containing:

a computer, of a possible multiplicity of types;

said computer having mounted therein a modem capable of connection to;

a hard wired telephone system, or;

a wireless message transmission system;

said computer containing various devices such as;

1. hard drives, upon which can be installed computer programs of many and varied types for a differing multiplicity of purposes;

2. and/or floppy disks of various sizes and shapes upon which can be installed these same programs.

In the present invention said drives or disks will have installed thereupon a method consisting of a unique computer program capable of encryption of plain text messages by selection of random encrypted characters from a Vigenere square matrix, and:

said drives or disks will also be capable of decryption of these encrypted messages utilizing the decryption computer program installed on the same devices as the encryption program;

said drives or disks, whichever being in use, and being installed in said computers will have these same computer programs installed thereon;

said computer programs, directing the interaction of a sliding scale having an affixed index pointer thereto with a Vigenere Square matrix, having within its outer confines numbered squares, each numbered square containing an encrypted character;

the actions of the sliding scale through various programmed motions as it interacts with the matrix, said actions being directed by said computer program, said sliding scale selecting encrypted characters upon input of literal message characters through the medium of the keyboard of the said computer system.

The computer programs that direct and control the actions of the sliding scale and its interaction with the Vignette Square matrix, in response to computer keyboard input, are embodied in the Algorithms disclosed on pages 8, 9, and 10 herein.

It is important to note that although the present invention has been described in the context of a fully functional computer system, those skilled in the art will appreciate that the computer programs of the present invention are capable of being distributed as a program product in a variety of forms, and that the present invention applies regardless of the particular type of signal bearing media used to actually carry out the distribution. Examples of signal bearing media include but are not limited to recordable type media such as hard drives, floppy disks or CD's of various types, and transmission type media such as analog or digital communication links.

While the invention has been shown and described with reference to a preferred embodiment, it will be understood by those skilled in the art that various changes in form and detail may be made without departing from the spirit and scope of the invention.

Further objects and features of this invention will be apparent when considered in conjunction with the accompanying drawings.

/* The Encryption algorithm reads in characters from a terminal, encrypts them and */
/* writes them out to an output file. When a Control-D character is typed, then the */
/* message is considered complete. */
Begin
char matrix [9216]; /* The matrix of 96 rows of 96 characters */
/* Fill 96 × 96 matrix with characters */
matrix[0] = ‘Y‘
matrix [1] = ‘p‘;
...
matrix [9214] = ‘x‘;
matrix [9215] = ‘&‘;
/* Fill alpha_array with the 96 characters */
alpha_array[0] = ‘A‘;
alpha_array[1] = ‘B‘;
...
alpha_array[94] = ‘‘;
alpha_array[95] = ‘<cr>‘;
start_pos = X; /* start position is a random number X */
entry_pt = X;
algorithm = start_pos/9216; /* algorithm = start_pos div 9216 */
start_pos = start_pos − (algorithm * 9216);
while not end of input(CTRL-D)

loop
read a character ch
if (ch == CTRL_D)

exit loop;

if (algoithm == 0)

start_pos = get_en_pos_0(ch, &start_pos);

else if (algorithm == 1)

start_pos = get_en_pos_1 (ch, &start_pos);

...
else if (algorithm == 7)

start_pos = get_en_pos_7(ch, &start_pos);

/* write to output file the encrypted character */
/* matrix[start_pos] is the encrypted character */

fwrite(matrix[start_pos]);
if (algoithm == 0)

start_pos = start_pos + 96 + (entry_pt mod 96);

else if (algorithm == n)
...
if (start_pos > 9215)

start_pos = start_pos − 9216; /* wrap back around to the beginning */

end loop

close output file
end
/* This is the get_en_pos_0 routine for algorithm 0. There are 8 different algorithms. */
/* A number between 0 and 95 is returned, representing one of 96 characters */
int get_en_pos_0(ch, start_pos)
begin
start_pos = start_pos / 96; /* get to the starting row */
if (ch <= ‘Z‘) and (ch >= ‘A‘)

tmp_pos = ch − ‘A‘ /* tmp_pos = 0..25 */

else if (ch <= ‘z‘) and (ch >= ‘a‘)

tmp_pos = 26 + (ch − ‘a‘); /* tmp_pos = 26..51 */

else if
...
else if (ch == ‘‘)

tmp_pos = 94;

else if (ch == ‘<cr>‘)

tmp_pos 95;

tmp_pos = tmp_pos + start_pos;
new_row = tmp_pos / 96;
if (new_row > start_row)

tmp_pos = tmp_pos − 96;

return tmp_pos
end

/* The Decryption algorithm reads in characters from an input file, decrypts them and */
/* writes them out to a terminal screen. */
Begin
char alpha_array[96]; /* The array that holds the 96 printable characters */
char matrix[9216]; /* The matrix of 96 rows of 96 characters */
/* Fill 96 × 96 matrix with characters */
matrix[0] = ‘Y‘;
matrix [1] = ‘p‘;
...
matrix [9214] = ‘x‘;
matrix [9215] = ‘&‘;
/* Fill alpha_array with the 96 characters */
alpha_array[0] = ‘A‘;
alpha_array[1] = ‘B‘;
...
alpha_array[94] = ‘‘;
alpha_array[95] = ‘<cr>‘;
start_pos = X; /* start position is a random number X */
entry_pt = X;
algorithm = start_pos/9216; /* algorithm = start_pos div 9216 */
start_pos = start_pos − (algorithm * 9216);
while not end of input file

loop
read a character ch
if (algoithm == 0)

call get_de_pos_0(&offset, &start_pos, ch);

else if (algorithm == 1)

call get_de_pos_1(&offset, &start_pos, ch);

...
else if (algorithm == 7)

call get_de_pos_7(&offset, &start_pos, ch);

/* alpha_array[offset] is the decrypted character */

printf(“%c”, alpha_array[offset]);
end loop

close input file
end
/* This is the get_de_pos_0 routine for algorithm 0. There are 8 different algorithms. */
/* A offset into the alpha_array is returned which represents one of 96 characters. */
/* An updated start_pos is also returned */
void get_de_pos_0(offset, start_pos, ch)
begin
offset = 0;
row = start_pos / 96; /* get to the starting row */
i = start_pos;

loop
new_row = i / 96;
if (new_row > row)

i = 1 − 96; /* wrap around to next row */

if (matrix[i] == ch)

exit loop; /* found the match */

offset = offset + 1;
i = i + 1;
end loop

start_pos = i + 96 + (entry_pt mod 96);
if (start_pos > 9215)

start_pos = start_pos − 9216; /* wrap around to the beginning */

end

We claim:

1. A. method for converting a literal message character to a literal enciphered character comprising the steps of:
a. selecting an entry point, into a Vigenere Square matrix containing intersecting rows and columns of consecutive numbered positions between 0 and 9215, and randomly scattered alphabets, numbers, and symbols providing encripted characters within said numbered positions;
b. positioning an index pointer mounted on a sliding scale having literal alphabets, numerals, and symbols appended thereto providing literal characters above the selected entry point;
c. selecting from the sliding scale's alphabets, numerals, and symbols, the initial letter, numeral, or symbol, mounted on said sliding scale to be transposed from a literal character on the sliding scale to an encriped character in the matrix;
d. entering the matrix from the selected letter, numeral, or symbol on the sliding scale to be transposed, and in the column in which the selected literal character is positioned, descend into the matrix stopping at the row in which the entry point is located, and at the intersection of said row and said column is the initial encrypted character to be transposed.

2. A method for converting a literal message containing literal message characters consisting of alphabets, numerals and symbols into an encrypted message containing literal encrypted message characters consisting of alphabets, numerals and symbols comprising the steps of:
a. selecting an entry point into a Viginere Square matrix, said matrix containing intersecting rows and columns of equal length having consecutive numbered positions from 0 to 9215, and randomly scattered characters of alphabets, numerals, and symbols, and provided within said numbered positions a randomly scattered character from said randomly scattered alphabets, numerals and symbols;
b. positioning an index pointer mounted on a sliding scale, above the selected entry point said sliding scale having literal characters of alphabets, numerals and symbols appended thereto;
c. selecting from the sliding scale's literal characters the letter, numeral or symbol, to thereby be transposed from a literal character on the sliding scale to a literal encrypted character in the matrix for use in the literal encrypted message;
d. descend into the matrix in the column in which the selected literal character is position, stopping at the row in which the entry point is located, at the intersection of said row and said column is the initial encrypted character of the message to be encrypted;
e. using the position of the initial selected encrypted letter, numeral or symbol as the second entry point proceed by positioning the index pointer mounted on the sliding scale, above the second entry point selecting from the sliding scale's literal characters the second letter, numeral or symbol, to be transposed from a literal character on the sliding scale to a literal encrypted character in the matrix and enter the matrix in the column in which the selected literal character is positioned, stopping at the row in which the entry point is located, choose the second literal encrypted character of the encrypted message from the same row as the second entry point;
f. proceeding in this manner from entry point to entry point, to thereby transpose any number of literal message characters into a literal encrypted message.

3. A computer system for converting literal message characters of any written national language into literal encrypted characters, said conversion implemented by inputs to said computer system via a computer keyboard, said inputs entered into a conversion device contained in said computer system, said conversion device comprised of any various type of floppy disks and hard drives for use in storage of computer programs, said conversion device containing computer programs including a matrix used in converting literal message characters into literal encrypted characters, said conversion device accepting said literal message character computer keyboard input, and converting said input into encrypted character output, said computer programs directing the programmed actions within said conversion device, wherein said keyboard inputs are entered into said conversion device, which conversion device thereupon acts in conjunction with said matrix, said matrix being prompted by said computer program to output a random encrypted literal character from said matrix, said encrypted output being a continuous datastream in any length, said encrypted datastream being dependent on the length of said inputs, said encrypted datastream output being maintained in a data file in said computer system, or installed on various media used for the storage of computer data.

4. A computer program product residing on computer useable medium used for converting literal message characters into literal encrypted characters, said literal message characters being input into a computer, via said computer keyboard, resulting in a computer output encrypted datastream from inputs of said litealmessage characters into said computer system, said computer program product comprising:
a. program code means for providing a multiplicity of literal message characters;
b. a sliding scale sub-program, said sliding scale sub-program acting in conjunction with;
c. a conversion matrix sub-program, wherein each entry of a literal message character contained in a datastream to be encrypted, is programmed such that it enters said sliding scale sub-program, whereby, in response to prompting of said sliding scale sub-program a companion encrypted character is selected from said conversion matrix, and;
d. program code means for outputing an encrypted message datastream comprised of all the encrypted characters obtained from said conversion matrix, said matrix having been prompted by said sliding scale, said sliding scale responding to computer keyboard inputs, and;
e. program code means for decrypting encrypted datastream messages which have been produced in accordance with this invention.
